(19) United States
(12) Patent Application Publication
(10) Pub. No.: US 2022/0012349 A1
(43) Pub. Date: Jan. 13, 2022

(54) METHOD AND SYSTEM FOR IDENTIFYING ANALOGOUS WELL LOG DATA WHILE MAINTAINING CONFIDENTIALITY

(71) Applicants: Andrew Douglas Kirkwood, Houston, TX (US); Charles S. Knobloch, Katy, TX (US)

(72) Inventors: Andrew Douglas Kirkwood, Houston, TX (US); Charles S. Knobloch, Katy, TX (US)

(21) Appl. No.: 17/369,650

(22) Filed: Jul. 7, 2021

Related U.S. Application Data
(60) Provisional application No. 63/049,806, filed on Jul. 9, 2020.

(51) Int. Cl. G06F 21/62

(52) U.S. Cl. CPC G06F 21/6209; G06F 2221/2141

(57) ABSTRACT

A method for identifying analogous well log data while maintaining data confidentiality. Well log data files are gathered and processed to extract patterns from them. For each pattern extracted, an alias identifier is created and stored to link the pattern back to its original well log data file. A test well log data file is selected, and a test pattern is extracted and pattern-matched against the stored patterns. A set of alias identifiers associated with the best matches from the pattern matching is returned. The alias identifiers are used to request access to the well log data files associated with the best matches, without exposing confidential information such as original data, ownership, well name and location.

### CLAIM OF PRIORITY

This application claims priority to provisional patent application Ser. No. 63/049,806 filed Jul. 9, 2020.

### TECHNICAL FIELD

Disclosed herein is a method and system for identifying analogous oil & gas well data while maintaining data confidentiality in the underlying well log data files and their attributes such as ownership, well name and location. Applications include the sale and leasing of well data, as well as the ability to commercially access associated resources around the well data such as analysis reports, expertise, and well construction and development methods.

### BACKGROUND OF THE INVENTION

In the oil & gas industry, access to geoscience and engineering talent and knowledge is critical for finding and developing hydrocarbon assets. One of the industry's biggest challenges has been the depletion of talent and knowledge as older workers retire, personnel costs increase, and the cyclical nature of the business makes it difficult to recruit and retain talent. In this environment, the ability to locate and share knowledge and information can provide significant value. Geoscientists and engineers typically work with oil & gas well log data as part of their job activities. Access to that data, and the associated knowledge and skills in its use, can help oil & gas companies and other geoscientists and engineers operate more efficiently and successfully. One way to discover where that data, knowledge and skill resides is to look for analogues to the existing well log data that one is endeavoring to use, and then acquire the analogue data and/or access to the resources associated with it. However, well log data is typically considered proprietary and highly confidential, which makes this type of discovery process extremely challenging. In addition, parties on both sides of the discovery process often need to keep their identities confidential so that they don't expose which oil & gas assets they are working on. Thus, there is a long felt need in the oil & gas industry for a way to discover analogous well log data in a “double-blind” fashion, while maintaining strict confidentiality in the data and its associated resources. Once the analogue data has been discovered, permissions can be obtained to commercially acquire the data and/or have access to the associated resources.

### BRIEF SUMMARY OF THE INVENTION

The present invention is a method for identifying analogous well log data while maintaining data confidentiality. Well log data files are gathered and processed to extract patterns from them. For each pattern extracted, an alias identifier is created and stored to link the pattern back to its original well log data file. A test well log data file is selected, and a test pattern is extracted and pattern-matched against the stored patterns. A set of alias identifiers associated with the best matches from the pattern matching is returned. The alias identifiers are used to request access to the well log data files associated with the best matches, without exposing confidential information such as original data, ownership, well name and location.

These and other features, objects and advantages of the invention will be disclosed, understood and appreciated by reference to the description of the preferred embodiments of the invention discussed below.

### BRIEF DESCRIPTION OF THE DRAWINGS

FIG. 1 is a schematic diagram illustrating an environment in which various examples of the invention presented herein are practiced;

FIG. 2 is a flowchart illustrating a method for identifying analogous well log characteristics in accordance with examples of the present invention.

### DETAILED DESCRIPTION OF THE INVENTION

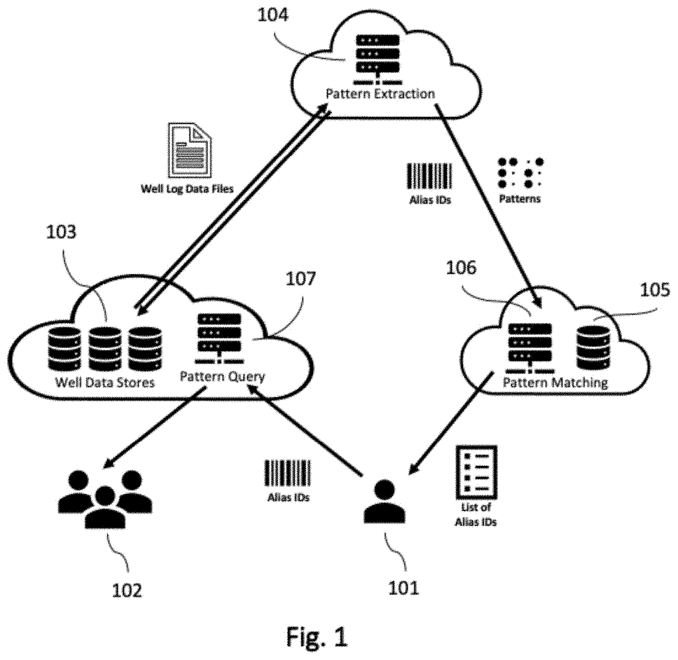

FIG. 1 is a schematic diagram illustrating an environment in which various examples of the invention presented herein are practiced. This involves a plurality of well data stores 103, a computing device 104 that generates patterns from well log data files that are stored in the well data stores 103, a database 105 that stores extracted patterns generated by a computing device 104 from the well log data files that come from the collection of well data stores 103, a computing device 106 that pattern-matches a pattern extracted from a test well log data file against the patterns stored in the database 105, and a computing device 107 that uses alias identifiers associated with the extracted patterns to locate the original well log data files in the well data stores 103.

To initiate the identification of analogous well log characteristics, well log data files are gathered from the plurality of data stores 103 and processed by a computing device 104 to extract patterns from them. In one example, the well data files have multiple owners 102 and reside in multiple data stores 103. In one example, the patterns are extracted using any one of a number of data mining or signal processing methods such as clustering, regression, and classification techniques. For each pattern extracted, an alias identifier is created to link the pattern back to its original well log data file. In one example, the alias identifier is a database pointer or search index number that links the pattern back to its original well log data file in the well data stores 103. In one example, to solve the problem of maintaining data confidentiality, only the patterns and their associated alias identifiers are stored in the pattern database 105. The patterns are stored in any number of formats including but not limited to arrays, parameter sets, or combinations thereof.

In order to identify analogous well log characteristics, an end user 101 selects a test well log data file from a data store 103 that the user has access to. A test pattern is extracted 104 and sent to a computing device 106 to be pattern-matched against a database of patterns 105. In one example, the pattern-matching 106 is achieved by using any one of a number of techniques including feature recognition and template matching. The application of these techniques generates a list of alias identifiers associated with the best matches from the pattern-matching 106. The list of alias identifiers is provided back to the end user 101. In one example, the list of alias identifiers is ranked according to a variety of criteria. The end user 101 selects the alias identifiers that they are interested in and sends them to a computing device 107 that performs a double-blind query to send requests to the original owners 102 of the well log data files. In one example, a double-blind query is a query that is performed in such a way that the identity of the end user 101 is not shared with the original owners 102 of the well log data files, and the identities of the original owners 102 are not shared with the end user 101. The double-blind query is used to send requests to the original owners 102 for access to the well log data files and/or their associated resources. No confidential information is shared with the end user 101 without the expressed consent of the original well log data file owners 102. In one example, the expressed consent of the original well log data files owners 102 is automated.

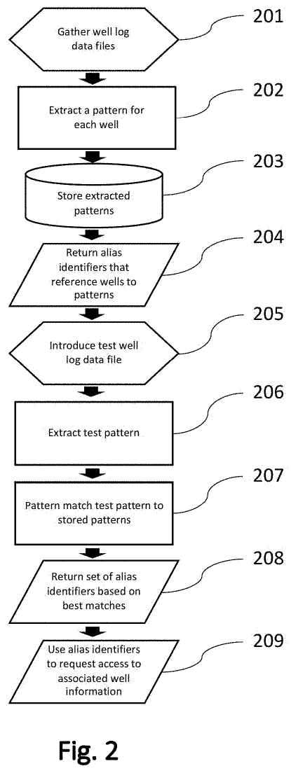

FIG. 2 is a flowchart illustrating a method for identifying analogous well log characteristics in accordance with examples of the present invention. The method starts with the gathering 201 of well log data files from a collection of wells. Patterns are then extracted 202 from the well log data files, in one example using a computing device 104. In one example, the extracted patterns are sent to a database 105 to be stored 203. Alias identifiers are returned 204 with each extracted pattern to be used for referencing back to the original well log data files. An end user 101 then introduces 205 a test well log data file from a data store, for example data store 103, that the end user has access to. A test pattern is extracted 206, using for example computing device 104, from the well log data files and sent to a computing device, for example computing device 106, to be pattern-matched 207 against the database of patterns 105. The pattern matching 207 returns a list of alias identifiers 208 associated with the best matches to the test pattern. The end user 101 selects the alias identifiers that they are interested in and uses them to perform a double-blind query to generate requests 209 to the original well log data owners 102 for access to the well log files and/or their associated resources.

Therefore, we claim:

1. A method for identifying analogous well log characteristics, comprising:
gathering well log data files from a collection of wells;
extracting a pattern from the well log data files for each well in the collection;
storing the extracted patterns from the collection of wells;
returning alias identifiers that reference each of the wells to their stored pattern; introducing a test well log data file to be pattern-matched;
extracting a test well log pattern from the test well log data file;
pattern matching the test well log pattern against the stored patterns;
returning a set of alias identifiers based on the best matches from the pattern matching; and
using the alias identifiers to request access rights to the well log data associated with the best matches from the pattern matching.
2. The method of claim 1 wherein the test well log data or its associated pattern is synthesized from a set of reservoir properties.
3. The method of claim 1 or claim 2 wherein the requested access rights include the identification of human experts who have worked on the associated data.
4. The method of claim 1 or claim 2 or claim 3 wherein the requested access rights include the identification of software applications that were used to process and analyze the associated data.
5. The method of claim 1 or claim 2 or claim 3 or claim 4 wherein the test well log data file or the well log data files from a collection of wells are digitally rights-managed.

### CONCLUSION

As can be appreciated, the workflow steps herein described are reduced to practice through computer code that is executed on one or more computing devices.

Although the present invention is described herein with reference to a specific preferred embodiment(s), many modifications and variations therein will readily occur to those with ordinary skill in the art. Accordingly, all such variations and modifications are included within the intended scope of the present invention as defined by the reference numerals used.

From the description contained herein, the features of any of the examples, especially as set forth in the claims, can be combined with each other in any meaningful manner to form further examples and/or embodiments.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to enable others skilled in the art to utilize the invention and such or other embodiments and with various modifications required by the particular applications or uses of the invention.

1. A method for identifying analogous well log characteristics, comprising:
gathering well log data files from a collection of wells;
extracting a pattern from the well log data files for each well in the collection;
storing the extracted patterns from the collection of wells;
returning alias identifiers that reference each of the wells to their stored pattern;
introducing a test well log data file to be pattern-matched;
extracting a test well log pattern from the test well log data file;
pattern matching the test well log pattern against the stored patterns;
returning a set of alias identifiers based on the best matches from the pattern matching; and
using the alias identifiers to request access rights to the well log data associated with the best matches from the pattern matching.

2. The method of claim 1 wherein the test well log data or its associated pattern is synthesized from a set of reservoir properties.

3. The method of claim 2 wherein the requested access rights include the identification of human experts who have worked on the associated data.

4. The method of claim 3 wherein the requested access rights include the identification of software applications that were used to process and analyze the associated data.

5. The method of claim 4 wherein the test well log data file or the well log data files from a collection of wells are digitally rights-managed.

6. The method of claim 3 wherein the test well log data file or the well log data files from a collection of wells are digitally rights-managed.

7. The method of claim 2 wherein the test well log data file or the well log data files from a collection of wells are digitally rights-managed.

8. The method of claim 1 wherein the test well log data file or the well log data files from a collection of wells are digitally rights-managed.

9. The method of claim 2 wherein the requested access rights include the identification of software applications that were used to process and analyze the associated data.

10. The method of claim 1 wherein the requested access rights include the identification of software applications that were used to process and analyze the associated data.

11. The method of claim 1 wherein the requested access rights include the identification of human experts who have worked on the associated data
